(19) United States
(12) Patent Application Publication
(10) Pub. No.: US 2011/0217877 A1
(43) Pub. Date: Sep. 8, 2011

(54) METHOD FOR SIMULTANEOUSLY FORMING A MECHANICAL AND ELECTRICAL CONNECTION BETWEEN TWO PARTS

(76) Inventor: Torsten Linz, Berlin (DE)

(21) Appl. No.: 13/121,909

(22) PCT Filed: Sep. 30, 2009
(86) PCT No.: PCT/EP09/07273

§ 371 Date: May 6, 2011

(30) Foreign Application Priority Data
Sep. 30, 2008 (DE) 10 2008 050 000.3

(51) Int. Cl. H01R 13/40; H01R 43/00

(52) U.S. Cl. 439/625; 29/885

(57) ABSTRACT

A method connects two parts, which overlap each other only partially and have electrically conducting structures, mechanically and electrically at the same time. For purposes of electrical insulation and/or for mechanical and/or chemical protection, at least one of the conductors is extensively covered with an electrically insulating material beyond the overlapping area and including the connection surface. In order to establish the connection, the conducting parts are pressed against each other in the area of the connection surfaces of said conducting parts and in the area surrounding said connection surfaces. An adhesive is used as the electrically insulating material. The adhesive is put into a sticky state during the connection, thereby forming an electrical contact between the electrical connection surfaces and in the area surrounding said electrical connection surfaces, after which the adhesive is brought into a permanently adhering state.

### CROSS-REFERENCE TO RELATED APPLICATIONS

The present application is a national phase application of PCT application PCT/EP2009/007273 filed pursuant to 35 U.S.C. §371, which claims priority to DE 10 2008 050 000.3 filed Sep. 30, 2008. Both applications are incorporated herein by reference in their entirety.

### TECHNICAL FIELD

The invention relates to a method for simultaneously forming a mechanical and electrical connection between two parts.

### BACKGROUND

In electronic and electrical systems, electrical conductors are normally provided, with the exception of their contact points, with electrical insulation that is intended simultaneously to form a mechanical or chemical protection. The insulations can include different materials corresponding to the respective requirement, in particular polymers being used.

Electrical contacts between two conductors are frequently effected with the help of adhesives. Both NCA (non-conductive adhesive) adhesives and ACA (anisotropically conductive adhesive) adhesives can be used. NCA is a non-conductive adhesive that keeps two conducting parts permanently in direct electrical contact. In order to produce the connection, the contact surfaces of the parts are pressed together until the adhesive surrounding the contact surfaces hardens at increased temperature. ACA adhesive includes small conducting particles that have a sufficiently large mutual spacing such that the adhesive is non-conducting in the uncompressed state. If, however, the ACA adhesive is pressed together, the particle spacing is reduced and conducting bridges result. The adhesive can then be hardened so that it permanently maintains these conducting bridges between the two contact surfaces. In the regions outside the contact surfaces, the adhesive is not compacted so that it remains non-conducting there and only a mechanical connection between the parts is produced.

The electrical conduction of such contacts is produced by ohmic conduction or the tunnel effect. It can also be produced by a mixture of these two effects.

The electrical contacting of two conducting parts, at least one of which is electrically insulated, has the disadvantage, however, that either the insulation needs to be removed in advance from the contact point or the not be applied at all at the contact point itself. This method step, which is implemented respectively before the actual contacting, is associated with additional operational complexity and the result can even be that specific connections can be produced in an undesired manner.

### SUMMARY

In some embodiments, the present invention is directed to a method for simultaneously forming a mechanical and electrical connection of two parts that cover each other only partially and that are provided with electrically conducting structures. At least one of the two parts is covered beyond the overlapping region over a large area including the connection surface with a layer made of electrically insulating material for electrical insulation and/or mechanical and/or chemical protection, the conducting parts being pressed together in the region of their connection surfaces. In this method, an additional step of local removal of the insulation or of selective application of the insulation is not required so that the method can be considerably simplified.

In some embodiments, using an adhesive as an electrically insulating material that is changed into a tacky state during the connection, while forming an electrical contact between the electrical connection surfaces of the conducting parts, between these and in the region surrounding these, and subsequently is converted into a non-tacky state, the process of changing the adhesive into the tacky state also results in its being changed into a flowable state in which it can be pressed out of the contact region by being pressed together or pressed together in the contact region. When using an NCA adhesive, the latter is pressed out of the contact region and, when using an ACA adhesive or ICA adhesive (isotropically conductive adhesive), the latter is at least pressed together so that, in each case, an electrical connection between the conducting parts is obtained. In the case of an NCA adhesive, the mechanical connection exists only outside the contact surface, while it is also present in the region of the contact surface in the case of an ACA adhesive or ICA adhesive.

Since pressing-together the conducting parts outside the electrical connection or contact surface must not lead to electrically insulating material being pressed to a significant degree to the side or becoming conductive, in some embodiments the electrical connection surface at least of one of the conductors is raised relative to the region surrounding said surface so that, when the electrical connection surfaces abut one on the other, a gap effecting adequate insulation still remains between the regions surrounding the electrical connection surfaces. In some embodiments, the raised connection surface can be, for example, a metal contact configured as a stud bump.

In some embodiments, changing the insulating material into the tacky and also flowable state is effected by supplying heat. If a heat-hardening adhesive is used, the conversion into the non-tacky state (hardening) takes place at increased temperature. If a hot-melt adhesive is used as insulating material, this process is achieved by cooling.

In some embodiments, an electrically insulating material that is non-tacky and in a solid state before the connection, can be brought simply into a tacky and flowable state by heating and subsequently returned again simply to the non-tacky and solid state by cooling.

In some embodiments, the heat supply can be effected by temperature increase of the surrounding space but also specifically by the effect of infrared- or light beams, ultrasound and also magnetic or electrical fields.

However, in some embodiments, it is possible to produce the tackiness and flowability by a chemical route. Thus, a volatile solvent that produces this state can be added to the insulating material. After the electrical contact is produced by pressure application, the solvent evaporates while pressure is maintained until the insulating material has solidified again.

In contrast to the known NCA or ACA adhesion, the adhesive insulates and/or protects at least one of the conducting parts wherever it does not contribute to the mechanical or electrical connection of the parts. The reason for this is that it remains unchanged at least in its function outside the connection and in addition fulfils the functions of an electrical insulator and/or mechanical and/or chemical protection. In the case of a thermally hardening adhesive, it is however also possible that the insulator/adhesive is hardened in total if this is desirable. This hardening however possibly reduces any previously present flexibility of one or both parts.

In some embodiments, the adhesive/insulator is firstly not a component of a conductor involved in the contacting. It is, as in the case of normal NCA adhesion, a separate part (e.g. a film or a paste). In contrast to the NCA adhesion, the adhesive, after the connection, also covers regions of one or both parts that do not contribute to the electrical or mechanical connection of the parts. The aim here is the electrical insulation and/or the mechanical and/or the chemical protection of the part or parts. The connection process is effected as in the case of a coated conductor, but in addition the adhesive will frequently be made tacky (and optionally applied with contact pressure) also wherever the latter is intended to be connected to the conductor. In some embodiments, the connection process is implemented such that an electrical contact is only produced wherever it is also desired and such that the insulation of the other regions is ensured. This can be implemented for example with a pressing tool that is raised at the place where the contact is intended to be produced and thus applies a higher pressure at this place. In other cases, it can be ensured solely by the topography of the parts to be connected (e.g. by a raised contact surface) that only the contact points of the parts are electrically connected.

The essential properties of the adhesive/insulator are hence that it insulates electrically and/or protects mechanically and/or chemically and that it can be changed by pressure and temperature such that it can assume the task of an NCA or ACA adhesive for electrical contacting.

In some embodiments, targeted specific connections can be produced by using different adhesives and other connections can be suppressed despite the otherwise uniform large-area type of treatment. The adhesives thereby differ for example in their type of reaction (e.g. heat hardening or thermoplastically) or in their reaction to physical influences (for example reaction by light or reaction by heat) or with respect to the parameters to which they react (e.g. different reaction temperatures). Thus by the choice of sequence of the physical influences or of the parameters, selectively specific connections can be produced in succession.

For example, in a woven sheet, respectively in warp and weft, a conducting thread is coated with a first adhesive and a conducting thread is coated with a second adhesive as insulator. The first adhesive is heat-hardening at 100° C. and the second adhesive is likewise heat-hardening but at 150° C. If the woven fabric is pressed between two plates and heated to 100° C., only the first adhesive liquefies and hardens after some time so that only the conducting threads with the first adhesive are contacted with each other. Subsequently, the temperature of the pressure plates is heated to 150° C. The first adhesive is already hardened and no longer softens. The second adhesive in contrast liquefies, hardens and connects thus only the conducting threads which are coated with the second adhesive. The same can be achieved with a combination of light-sensitive adhesives or adhesives which react to ultrasound.

In some embodiments, a tool with raised portions or a special topography of the parts to be connected is not required although of course these can be used nevertheless in order to increase the pressure at the contact points.

The term “conducting part” is not restricted to wires or cables, but instead is intended to include everything that can assume the function of electrical conduction, such as for example conductors on printed circuit boards, conductive strips, cable strips, conductive threads of all types, textile conductive sheets, textile sheets with conductive structures and the like.

Conductive threads are electrical conductors of a thread, yarn or fiber character, such e.g. such as coated fibers or metallic fibers or yarns consisting of non-conductive and conductive fibers and/or wires.

Textile sheets can be completely conducting or have partially conducting structures which are insulated completely or partially. Textile sheets can be produced for example from conducting textile threads by weaving, knitting or embroidering or also by conductive coatings on textile sheets. It may be mentioned that also fleeces are intended to be understood as textile sheets, even if strictly speaking, these are not termed textiles.

In some embodiments, a special application can be effected for display or illumination purposes. Light-emitting components (e.g. LEDs) that are contactable on both sides are disposed between two completely or structured conductive textile or non-textile surfaces. Both surfaces and the light-emitting components are glued together with an insulating material (adhesive). This adhesive thereby keeps the contacts of the light-emitting component in electrical contact with respectively one of the two surfaces and insulates these surfaces from each other at the same time. The adhesive can thereby be applied over the whole surface on one or both surfaces but also can be applied between the surfaces as a separate part (e.g. as film, powder, paste, spray etc.).

In some embodiments, LEDs that are also contactable on one side can be disposed on only one structured, conductive textile or non-textile sheet.

In some embodiments, the adhesive can instead also be applied on the entire surface on individual textile or non-textile conductors that are situated on or in the surface.

In some embodiments, if the light-emitting component has more than two terminals (e.g. RGB LEDs) that also have a plurality of contacts with at least one of the two surfaces, textile sheets having structured conductors are used in order to supply the individual terminals selectively.

Instead of the light-emitting components, also sensors of all types, such as acceleration sensors, temperature sensors, thermoelements, moisture sensors, light sensors etc., actuators of all types, such as vibrators, heating elements, piezoelectric elements etc., electronic modules of all types or antennae of all types, can be contacted in the described manner.

In some embodiments, the electrically conducting part that is covered over a large area with the layer made of electrically insulating material can be a semiconductor substrate that is provided with strip conductors covered by the layer made of electrically insulating material, the mechanical and electrical connection being intended to be produced between the latter and at least one flip-chip and/or at least one passive component. The strip conductors thereby extend at least partially outside the overlapping region of the parts to be connected.

### BRIEF DESCRIPTION OF THE FIGURES

The invention is explained subsequently in more detail with reference to the embodiments represented in the Figures.

FIG. 1 illustrates a flat strip cable or conductor strip and a flat substrate with contact surfaces, on the one hand, before connection and, on the other hand, after mutual connection thereof.

FIG. 2 illustrates a light diode (LED) embedded between two textile sheets.

FIG. 3 illustrates a plan view on a substrate provided with strip conductors and a perpendicular cross-section through said substrate along the line A-A of FIG. 2.

### DETAILED DESCRIPTION

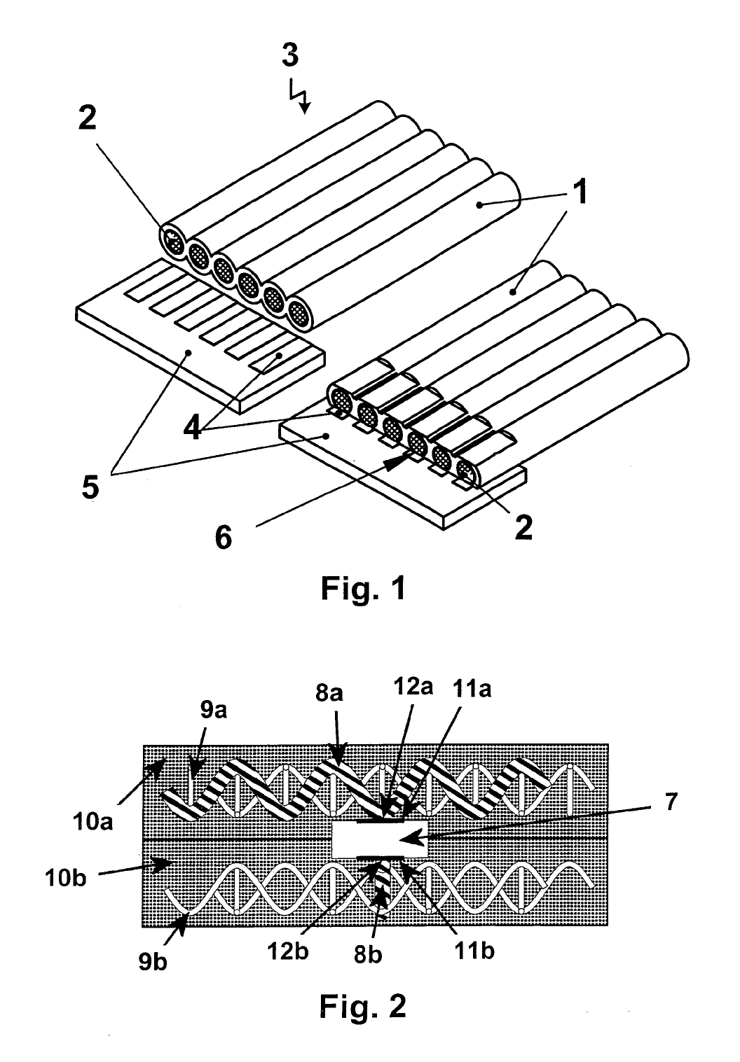

In some embodiments, as shown in FIG. 1, there are represented separately on the left side a flat strip cable 3 including a plurality of parallel conductors 2 that are covered with respectively one insulation layer 1 and also a flat substrate 5 provided with contact surfaces 4. The round conductors 2 have the same mutual spacing as the contact surfaces 4 on the substrate 5.

In order to obtain an electrical and mechanical connection between the flat strip cable 3 and the substrate 5, which is represented on the right side of FIG. 1, at least the front region of the flat strip cable 3 overlapping the substrate 5 was heated such that the corresponding region of the insulation layer 1 became tacky and flowable. This region was then pressed from above against the region of the substrate 5 having the contact surfaces 4, a contact surface 4 being situated respectively opposite a conductor 2. The insulation layer 1 was thereby pressed to the side or pressed together between a conductor 2 and the associated contact surface 4, according to the type of property thereof (either NCA or ACA), as a result of which an electrical connection 6 adequate for the respective purpose of use was produced between these and, between the contact surfaces 4, the insulation layer 1 was pressed against the substrate 5 over the entire area. As a result of subsequent hardening or solidifying of the heat-treated regions of the insulation layer 1, a strong mechanical connection between the substrate 5 and the flat strip cable 3 was obtained, said insulation layer also permanently maintaining the electrical connections 6.

FIG. 2 shows an embodiment of an LED 7 embedded between two textile fabric layers. The upper fabric layer consists of a thread-shaped conductor 8a that extends in the drawing plane (e.g. weft), and also non-conducting textile threads 9a that extend both in the drawing plane and perpendicular to the latter (e.g. warp). The fabric is embedded in a layer 10 made of insulating material/adhesive. In the same way, the lower fabric layer includes a thread-shaped conductor 8b that extends perpendicular to the drawing plane and also non-conducting textile threads 9b that are embedded in a layer 10b made of insulating material/adhesive. The course of the conductors 8a and 8b, perpendicular to each other, enables selective actuation of LEDs that are disposed in a matrix between the fabric layers. The layers 10a and 10b are light-permeable so that an illuminating LED is visible from outside.

One terminal contact 11a or 11b is situated on the upper and the lower surface of the LED 7, respectively. If the fabric layers are heated on the surface and pressed together, the layers 10a and 10b stick together outside the LEDs. The conductor 8a and the terminal contact 11a, on the one hand, and the conductor 8b and the terminal contact 11b, on the other hand, are pressed together so that an electrical contact 12a or 12b is formed between them. Outside the contact surfaces, the LED 7 also sticks to the layers 10a and 10b. After hardening or solidifying of the layers 10a and 10b, a stable matrix including LEDs that are contacted with thread-shaped conductors in the desired manner are obtained such that the LEDs can be selectively actuated.

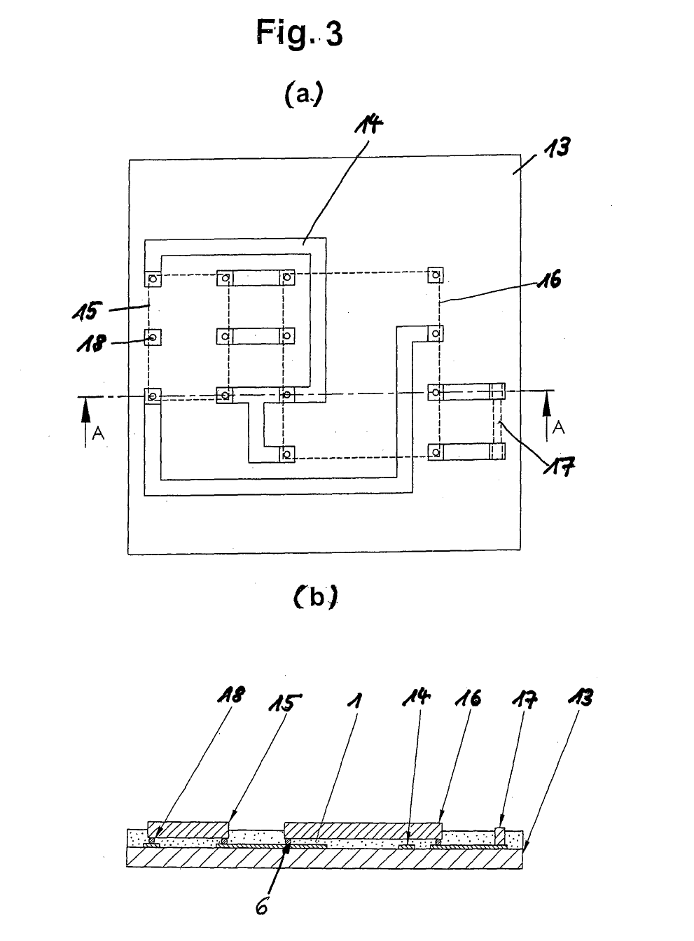

FIG. 3 (a) shows a plan view on a substrate 13, e.g. a flexible substrate or an FR4 substrate that carries strip conductors 14 on the upper side. This side is completely covered, including the strip conductors 14, with a layer made of electrically insulating material 1. After forming the strip conductors 14 on the substrate 13, this layer was applied in order to insulate the substrate surface including the strip conductors 14 electrically and to protect them against mechanical influences.

In order to mechanically and electrically connect the substrate 13 to flip-chips 15 and 16 and to a passive component 17, the electrically insulating material 1 is firstly brought, for example, by heating into a tacky and flowable state. The flip-chips 15 and 16 and the component 17 are then pressed in the correct position against the upper side of the substrate 13 by their side carrying contacts 18 so that the protruding contacts 18 press aside the insulating material 1 if it is an NCA adhesive and come into direct contact with a strip conductor or, if it is an ACA adhesive, are pressed together such that it becomes electrically conducting between the contacts 18 and the strip conductors 14 and remains insulating in the remaining regions.

In this state, the material 1 is returned to its previous, mechanically stable state, for example by cooling, the substrate 13, on the one hand, and the flip-chips 15 and 16 and the component 17 remain permanently connected mechanically, as a result of which also the electrical connection 6 between the contacts 18 and the strip conductors 14 remains permanently connected. The substrate 13 and the strip conductors 14 are permanently electrically insulated and mechanically protected by the material 1 over the entire surface, i.e. even outside the overlapping regions, with the flip-chips 15 and 16 and also the component 17. Regions of the strip conductors 14 that extend between the substrate 13 and the flip-chips 15 or 16 and opposite which there are no contacts 18, are likewise insulated and protected by the material 1.

In addition to the insulator/adhesive material defined quite generally in this invention, in some embodiments, thermoplastic polyurethane has proved to be suitable as NCA adhesive and insulator.

1-30. (canceled)

31. A method for simultaneously forming a mechanical and electrical connection between two parts that overlap each other in an overlapping region and are provided with electrically conducting structures having connection surfaces, the method comprising:
covering at least one of the two parts beyond the overlapping region, including a connection surface, with a layer of electrically insulating material including an adhesive for electrical insulation and/or mechanical and/or chemical protection;
changing the insulating material into a tacky and flowable state;
pressing the electrically conducting structures together in a region of their connection surfaces while the insulating material is in a tacky and flowable state to form an electrical contact; and
converting the insulating material into a permanently adhesive state in order to maintain the electrical contact.

32. The method of claim 31, wherein the layer of electrically insulating material is in a mechanically stable state before forming the connection and is converted into a tacky and flowable state for forming the connection.

33. The method of claim 31, wherein changing the insulating material into the tacky state is comprises supplying energy to the adhesive.

34. The method of claim 31, wherein converting the insulating material from the tacky and flowable state into the permanently adhesive state comprises cooling.

35. The method of claim 31, wherein the insulating material comprises a hot-melt adhesive.

36. The method of claim 31, wherein the insulating material comprises a heat-hardening adhesive.

37. The method of claim 31, wherein the insulating material comprises polyurethane.

38. The method of claim 31, wherein the insulating material is brought into the tacky state by chemical treatment.

39. The method of claim 38, wherein the insulating material is mixed with a volatile solvent that returns the insulating material to the permanently adhesive state by evaporation.

40. The method of claim 31, wherein the insulating material is applied as a separate part on at least one of the electrically conducting parts.

41. The method of claim 40, wherein the insulating part is applied as a film or paste.

42. The method of claim 31, wherein the insulating material is compressed in the tacky and flowable state by pressing together the electrical connection surfaces of the two parts or is pressed out of the electrical connection surface, and then the insulating material is converted into the permanently adhesive state.

43. The method of claim 42, wherein the insulating material comprises an adhesive that is mixed with conducting particles and that becomes conducting by pressing together.

44. The method of claim 42, wherein the insulating material comprises a non-conducting adhesive which, when pressing together the electrical connection surfaces of the two parts, is pressed out from between the electrical connection surfaces.

45. The method of claim 31, wherein the electrical connection surface of at least one of the conductors is raised relative to the region surrounding it.

46. The method of claim 45, wherein the raised electrical connection surface comprises a metal contact configured as a stud bump.

47. The method of claim 31, wherein different adhesives are used for different connections to be produced selectively between at least two parts.

48. The method of claim 31, wherein at least one of the conducting parts comprises a cable or cable strip insulated with the adhesive.

49. The method of claim 31, wherein at least one of the conducting parts comprises a conductive thread, wire or flex insulated with the adhesive.

50. The method of claim 49, wherein at least one of the conducting parts comprises a thread, wire or flex that is disposed on or embedded in a textile layer or nonwoven layer.

51. The method of claim 49, wherein the thread is formed from electrically conducting fibers or from a yarn including electrically conducting and non-conducting fibers.

52. The method of claim 31, wherein one of the conducting parts comprises a terminal contact of a light-emitting component, a terminal contact of a sensor or actuator or a terminal contact of an antenna.

53. The method of claim 31, wherein the electrically conducting part that is covered over a large area with the layer of electrically insulating material comprises a substrate that is provided with strip conductors covered by the layer of electrically insulating material.

54. The method of claim 54, wherein the mechanical and electrical connection is produced between the substrate and at least one flip-chip to be applied on the substrate.

55. The method of claim 53, wherein the mechanical and electrical connection is produced between the substrate and at least one passive component to be applied on the substrate.

56. The method of claim 54, wherein the strip conductors extend at least partially outside the overlapping region between the substrate and the flip-chips

57. The method of claim 55, wherein the strip conductors extend at least partially outside the overlapping region between the substrate and the passive components.

58. The method of claim 31, wherein the electrically conducting parts are intersecting conductors.

59. A connection between two electrically conducting parts that overlap each in an overlapping region and at least the one of which, for electrical insulation and/or for mechanical and/or chemical protection, is covered beyond the overlapping region over a large area with a layer made of electrically insulating material;
wherein the insulating material comprises an adhesive that holds the electrically conducting parts together mechanically in the overlapping region.
